(19) United States
(12) Patent Application Publication
(10) Pub. No.: US 2008/0084187 A1
(43) Pub. Date: Apr. 10, 2008

(54) Mobile Power Supply

(75) Inventor: Anthony J. Cutrona, Vaughan (CA)

Correspondence Address: SHOEMAKER AND MATTARE, LTD, 10 POST OFFICE ROAD - SUITE 110, SILVER SPRING, MD, 20910, US

(73) Assignee: POWERCART SYSTEMS INC., Mississauga (CA)

(21) Appl. No.: 11/538,625

(22) Filed: Oct. 4, 2006

(51) Int. Cl. H02J 7/00

(52) U.S. Cl. 320/132

(57) ABSTRACT

A system for controlling battery usage in a mobile power supply includes a controller for monitoring a state of charge of the battery and the voltage and switching off all power from the battery when the battery reaches a predetermined power off state of charge or a low voltage condition. A switch provides power to the controller in response to receipt of power from an other source, thereby causing the controller to resume monitoring of the state of charge of the battery. When the battery reaches a predetermined power off state of charge, the controller switches off power from the battery. The switch turns the controller back on in response to receipt of power from the other source. When the battery is recharged to a predetermined restart state of charge and when the voltage reaches a restart voltage, power from the battery is switched back on.

### TECHNICAL FIELD

The present invention relates to mobile power supplies for use with, for example, wheeled carts such as patient point of care carts in health care facilities, for providing portable power for various applications.

### BACKGROUND OF THE INVENTION

Wheeled carts including mobile power supplies are increasingly being used in various applications including retail applications for mobile, temporary or portable checkout locations, warehousing applications for barcode reading, barcode labeling, radio frequency identification (RFID) tag labeling and reading, and inventory tracking, and health care applications for carrying and powering patient care equipment such as monitors, pumps, ventilators or computers for tracking patient related data. With this increase in popularity, there is also an increase in the demand for improvements in wheeled carts including mobile power supplies.

Referring in particular to the health care environment, an uninterrupted supply of power to devices such as monitoring equipment including computers for tracking patient related data is often important, even when moving a patient from one location to another. Thus, a point of care cart including a battery power supply is used and transported with the patient and associated equipment.

Batteries that are used in such carts convert stored chemical energy into electrical energy. These batteries have a limited lifetime, which is nonlinearly related to the chemical composition, application, environmental factors, and use/maintenance. Performance of batteries such as lead-acid batteries degrades quickly with deep discharge of the battery and cycling to deep discharge of the battery, thereby further reducing the expected lifetime of the battery.

Some mobile power supply systems include a sleep mode or reduced power state in which battery draw is reduced when the battery reaches a predetermined state of charge or low voltage condition. Thus, power to peripheral devices is shut off or reduced when the state of charge of the battery reaches a predetermined low point or the voltage reaches a predetermined low voltage condition. The power is returned when the battery is recharged. In such prior art devices, a controller is powered by the battery in order to continually monitor the state of charge of the battery or the voltage and to return power to the peripheral devices when the battery state of charge or voltage reaches a predetermined limit. Thus, the battery continues to discharge after reaching the predetermined state of charge which leads to deep discharge of the battery, resulting in battery degradation and reduced battery lifetime.

It is desirable to provide an improved mobile power supply to reduce the likelihood of early degradation of the battery due to deep discharging.

### SUMMARY OF THE INVENTION

According to one aspect, there is provided a system for controlling battery usage in a mobile power supply includes a controller for monitoring a state of charge of the battery or voltage and switching off all power from the battery when the battery reaches a predetermined power off state of charge or low voltage. A switch provides power to the controller in response to receipt of power from an other source, thereby causing the controller to resume monitoring of the state of charge and voltage of the battery. When the battery reaches a predetermined power off state of charge or voltage, the controller switches off power from the battery. The resume switch turns on the controller in response to receipt of power from the other source. When the battery is recharged to a predetermined restart state of charge and voltage, power from the battery is switched back on.

According to another aspect, there is provided a mobile power supply. The power supply includes a charger connectable to an AC power supply for charging the battery, a power switch connectable to the battery for turning power from the battery on and off, an inverter connectable to the battery for converting direct current from the battery to alternating current for supplying power to a load, a controller for controlling the power switch for turning off all power from the battery when the battery reaches a predetermined power off state of charge or voltage, and a resume switch for resuming power to the controller in response to receipt of power from the AC power supply, thereby causing the controller to resume monitoring of the state of charge and voltage of the battery. When the battery reaches a predetermined power off state of charge or voltage, the controller switches off the power switch and turns off all power from the battery including power to itself. The controller is turned back on by the resume switch, in response to receipt of power from the AC power supply. When the battery is recharged and reaches a predetermined restart state of charge and voltage, the controller switches on the power switch.

According to yet another aspect, there is provided a mobile cart for use with a battery. The mobile cart includes a body, a plurality of wheels connected to and supporting the body for rolling the body across a surface, and a power supply system connected to the body for providing power to peripheral devices. The power supply system includes an AC input device for connecting to an AC power source, a charger connected to the AC input device, a power switch for connection to the battery for turning power from the battery on and off, an inverter for connection to the battery for converting direct current from the battery to alternating current for supplying AC power to a peripheral device, a controller for controlling the power switch for turning off all power from the battery when the battery reaches a predetermined power off state of charge or voltage, a resume switch for resuming power to the controller in response to receipt of power from the AC power supply, thereby causing the controller to resume monitoring of the state of charge and voltage of the battery, and a peripheral output for connection of the peripheral device. When the battery reaches a predetermined power off state of charge or voltage, the controller switches off the power switch and turns off all power from the battery, including power to itself. The controller is turned back on by the resume switch, in response to receipt of power from the AC power supply. When the battery is recharged and reaches a predetermined restart state of charge and voltage, the controller switches on the power switch.

Advantageously, all power from the battery is turned off when the battery reaches a predetermined low state of charge or low voltage condition. Thus power is turned off to the peripherals and to the microcontroller that monitors the battery and switches off the power to peripherals. A restart switch is connected to the microcontroller to turn the microcontroller back on when the analog switch receives AC power. Thus, when the mobile power supply is plugged in to an AC power outlet, the resume switch causes the microcontroller to turn back on and resume monitoring of the battery state of charge and voltage. When the battery is recharged sufficiently to reach a predetermined restart state of charge and voltage, the power switch back on to provide power from the battery when the AC power in unplugged.

### BRIEF DESCRIPTION OF THE DRAWINGS

An embodiment of the present invention will now be described, by way of example only, with reference to the attached Figure, in which:

FIG. 1 is a schematic representation of a mobile power supply according to one embodiment of the present invention; and

FIG. 2 is a perspective view of an exemplary mobile cart for use with the mobile power supply of FIG. 1.

### DETAILED DESCRIPTION OF THE PREFERRED EMBODIMENT

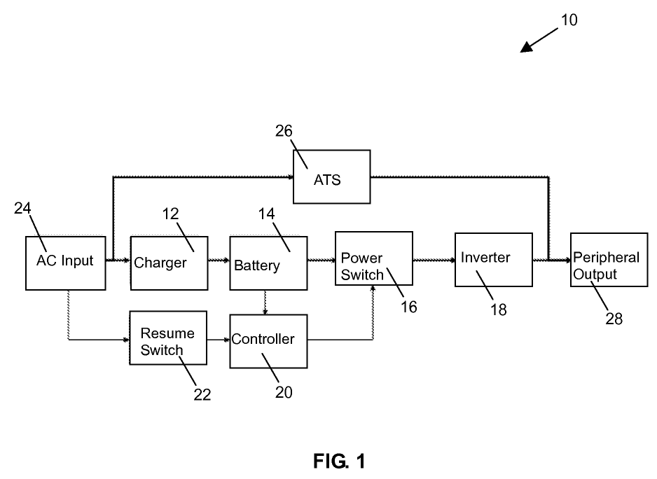

Reference is first made to FIG. 1 which shows a schematic representation of a mobile power supply including a system for controlling battery usage according to one embodiment of the present invention. The mobile power supply in the schematic illustration of FIG. 1 is indicated generally by the numeral 10. The mobile power supply 10 includes a charger 12 connectable to an AC power supply for charging the battery 14. A power switch 16 is connectable to the battery 14 for turning power from the battery 14 on and off and an inverter 18 is connectable to the battery 14 for converting direct current from the battery 14 to alternating current for supplying power to a load. A controller 20 is provided for controlling the power switch 16 for turning off all power from the battery 14 when the battery 14 reaches a predetermined power off state of charge or low voltage condition. A resume switch 22 is provided for resuming power to the controller 20 in response to receipt of power from the AC power supply, thereby causing the controller 20 to resume monitoring of the state of charge and voltage of the battery 14. When the battery 14 reaches a predetermined power off state of charge or low voltage condition, the controller 20 switches off the power switch and turns off all power from the battery 14. When the battery 14 is recharged and reaches a predetermined restart state of charge or voltage condition, the controller 20 switches on the power switch.

The mobile power supply 10 will now be further described with continued reference to FIG. 1. Setup and connection of the mobile power supply 10 is well within the grasp of one skilled in the art having regard to the present description. An AC input 24, in the form of a plug for plugging into a wall socket, provides AC power to the mobile power supply 10. From the AC input 24, power goes to the charger 12 and to an automatic transfer switch 26 which will be described below. Power also is provided to the resume switch 22.

The charger 12 receives AC power when the AC input 24 is plugged into a wall socket and converts AC to DC for charging the battery 14. It will be appreciated that the battery is a replaceable consumable and stores chemical energy for conversion into electrical energy. In the present embodiment, the battery is a lead-acid battery.

The battery 14 is connected to the power switch 16 which is, in turn, connected to the inverter 18 for shutting off power from the battery 14 by disconnecting the battery 14 and the inverter 18. The power switch 16 is controlled by the controller 20 which is connected to the power switch 16 for providing control signals thereto. It will be appreciated that the inverter draws DC from the battery 26, converts to AC and provides AC out to the peripheral output 28, in the form of a mobile power supply socket, when power is drawn by a peripheral device and the AC input 24 is not plugged into an operating wall socket.

The automatic transfer switch 26 is also connected to the AC input 24 to the peripheral output 28 for switching to provide the peripheral output 28 with power from the AC input 24 or from the battery 14 (via the power switch 16 and the inverter 18) depending on whether or not the AC input 24 is plugged into a wall socket. Thus, when plugged into an operating wall socket and receiving power therefrom, the power delivered to the peripheral output 28 comes from the AC input 24. When not plugged into an operating wall socket, the power is drawn from the battery 14 (via the power switch 16 and the inverter 18). Therefore, power is not drawn from the battery 14 by the inverter 18 during charging of the battery 14 and power is drawn from the battery 14 when power is not supplied at the AC input 24 and when the power switch is on.

The resume switch 22 is also connected to the AC input 24 for receiving AC therefrom and for providing a digital output to the controller 20. The controller 20 is, in turn, connected to both the battery 14 and the power switch 16. The controller 20 is a programmable microcontroller that monitors the battery 14, the battery state of charge and the voltage. As indicated, the controller 20 is connected to the power switch 16 to control the power switch 16 by turning off the power switch 16 when it is determined that the battery 14 has reached a predetermined low state of charge (to keep the battery from deep discharge) or low voltage condition. The controller 20 also turns itself off to stop any further draw from the battery 14 when the battery 14 has reached the predetermined low state of charge or low voltage condition. Thus, the controller 20 stops drawing from the battery 14 when the battery reaches the predetermined low state of charge or low voltage condition, thereby inhibiting deep discharge of the battery 14 that causes fast battery degradation compared to the degradation of the battery during normal use. The controller 20 also turns the power switch 26 back on when the controller 20 determines that a predetermined restart state of charge and voltage condition is reached after charging the battery 14. This is accomplished after the controller 20 is first turned back on by the resume switch 22, as described further below.

As indicated, the controller 20 is programmable for monitoring the batter, battery state of charge and voltage condition, and for setting the low state of charge point, low voltage condition point and the restart state of charge point and restart voltage point. It will be appreciated that the low state of charge point and the restart state of charge point can be set depending on many factors including the battery and the intended use of the battery. Similarly, the low voltage condition point and restart voltage point can be set depending on many factors including the battery and the intended use of the battery. It will also be appreciated that the low state of charge and the restart state of charge can be preset by the manufacturer or by the user. Similarly, the low voltage condition point and restart voltage point can be preset by the manufacturer or by the user.

The resume switch 22 is an analog switch in the form of an analog rectifier circuit that is connected to the AC input 24 and, in turn, to the controller. When the AC input 24 is plugged into an operating wall socket and is thereby connected to an AC power supply, the resume switch 22 (analog rectifier circuit) converts the AC received from the AC input 24, into a digital output that is sent to the controller 20. Thus, the resume switch 22 converts 120V AC power to digital output that is provided to the controller 20 to turn the controller 20 back on after the controller has been turned off. Thus, when the AC input is connected to an AC power supply, the resume switch 22 turns the controller 20 back on. The controller 20 then continues to monitor the battery 14 and turns on the power switch 16 when the battery 14 reaches a predetermined restart state of charge and restart voltage point.

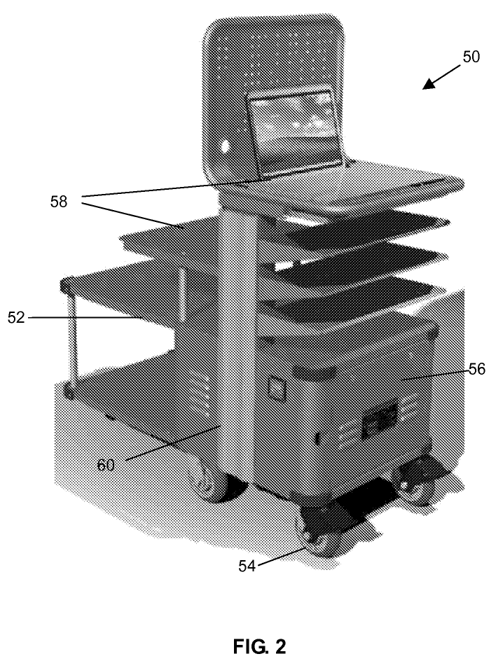

Referring now to FIG. 2, a mobile cart is shown and indicated generally by the numeral 50. The mobile cart 50 includes a body 52 to which wheels 54 are attached for rolling the cart 50 along a surface. The mobile power supply 10 is included in a lower housing portion 56 of the body 52 for providing a supply of power to peripheral devices such as a computer. The mobile power supply 10 (not shown in FIG. 2) of the present embodiment is similar to that described above and therefore need not be further described herein. In the present embodiment, the cart body 52 includes working surfaces 58 for receiving devices, such as a keyboard and other suitable devices. The working surfaces 58 are connected to the lower housing portion 56 by legs 60 that are adjustable for adjusting the height of the working surfaces.

In use, peripheral devices are connected to the peripheral output 28 of the mobile power supply 10. When the AC input 24 is not plugged into an operating wall socket, power is drawn from the battery, through the power switch 16 and is converted to AC at the inverter 18. Thus, power is provided to the peripheral devices. During use, the controller 20 continually monitors the battery 14. After a period of time, the battery 14 reaches the low state of charge which is detected by the controller 20. The controller 20 then switches the power switch 16 off and turns off to stop power from being drawn from the battery 14 and thereby reduce the likelihood of deep discharge degradation of the battery 14. To charge the battery 14, the AC input 24 is plugged into an operating wall socket causing the charger 12 to charge the battery. When the AC input 24 is plugged into the operating wall socket, the resume switch 22 converts the AC received from the AC input 24 to a digital output that is provided to the controller 20, thereby turning the controller 20 back on. The controller 20 then resumes monitoring of the battery 14 and turns the power switch 16 back on when the battery state of charge reaches the predetermined restart state of charge and the voltage is at a predetermined restart voltage. Thus, power can again be drawn from the battery 14 when the AC input 24 is not connected to an AC power supply. It will be appreciated that although the power switch 16 is turned back on, power is still provided to the peripheral devices from the AC input 24, via the automatic transfer switch 26 and the peripheral output 28, until the AC input 24 is disconnected from the AC power supply.

Alternatively, the battery 14 reaches a low voltage condition point during use and the controller 20 switches the power switch 16 off and turns off power to itself to stop power from being drawn from the battery 14. The controller 20 again resumes monitoring only after being turned on by the resume switch 22 in response to receipt of AC power. The controller 20 then resumes monitoring of the battery 14 and turns the power switch 16 back on when the battery state of charge reaches the predetermined restart state of charge and the voltage reaches a predetermined restart voltage.

It will be appreciated that the simplified schematic representation of the mobile power supply 10 is provided for exemplary purposes. Other features can be provided as will occur to those skilled in the art. For example, isolation transformers, over-voltage control relays, heat sinks and other features are not shown or described herein. However, those skilled in the art will appreciate that at least some of these features are provided in the mobile power supply 10.

It will also be appreciated that the mobile power supply 10 can be equipped with an output for providing the user with warnings, for example, when the battery state of charge is getting low or when the voltage is low. Thus, a warning is provided to the user prior to shutting of the power switch 16. Other warnings and output can also be provided.

It will be appreciated that, although embodiments of the invention have been described and illustrated in detail, various modifications and changes may be made. All such alternatives and modifications are believed to be within the scope of the invention as defined by the claims appended hereto.

What is claimed is:

1. A system for controlling battery usage in a mobile power supply, the system comprising:
a controller for monitoring a said battery and switching off all power from the battery when said battery reaches a predetermined power off state of charge; and
a switch for providing power to said controller in response to receipt of power from an other source, thereby causing the controller to resume monitoring of the battery, wherein
when said battery reaches a predetermined power off state of charge, said controller switches off power from said battery and when said battery is recharged to a predetermined restart state of charge, power from said battery is switched back on for providing power to peripheral devices when said other source is no longer available.

2. The system according to claim 1, wherein said controller further monitors battery voltage and switches off all power from said battery when said battery reaches a predetermined low voltage, and wherein when said controller resumes monitoring of the battery, power from the battery is switched back on when said battery also reaches a predetermined voltage.

3. The system according to claim 1, wherein said other source comprises an AC power supply.

4. The system according to claim 3, comprising a charger connectable to said AC power supply for charging said battery.

5. The system according to claim 3, comprising an automatic transfer switch for automatically providing power to a load from said AC power supply, when said AC power supply is provided.

6. The system according to claim 3, comprising an inverter for converting direct current to alternating current for supplying power to a load.

7. The system according to claim 6, wherein said controller is connected to a power switch between said battery and said inverter and said controller turns off said switch to switch off power from the battery.

8. The system according to claim 7, wherein said controller turns itself off to switch off power from the battery.

9. The system according to claim 8, wherein said switch for providing power to said controller comprises an analog rectifier circuit for turning on said controller.

10. A mobile power supply comprising:
a charger connectable to an AC power supply for charging the battery;
a power switch connectable to said battery for turning power from said battery on and off;
an inverter connectable to said battery for converting direct current from said battery to alternating current for supplying power to a load;
a controller for controlling said power switch for turning off all power from the battery when said battery reaches a predetermined power off state of charge; and
a resume switch for resuming power to said controller in response to receipt of power from said AC power supply, thereby causing the controller to resume monitoring of the state of charge of said battery, wherein
when said battery reaches a predetermined power off state of charge, said controller switches off said power switch and turns off all power from said battery and when said battery is recharged and reaches a predetermined restart state of charge, said controller switches on said power switch.

11. The mobile power supply according to claim 10, wherein said controller further monitors battery voltage and switches off all power from said battery when said battery reaches a predetermined low voltage, and wherein when said controller resumes monitoring of the battery, power from the battery is switched back on when said battery also reaches a predetermined voltage.

12. The mobile power supply according to claim 10, comprising an automatic transfer switch for automatically providing power to a load from said AC power supply, when said AC power supply is connected.

13. The mobile power supply according to claim 10, wherein said controller turns itself off to switch off power from the battery when said battery reaches said predetermined power off state of charge.

14. The mobile power supply according to claim 10, wherein said resume switch comprises an analog rectifier circuit for turning on said controller.

15. The mobile power supply according to claim 10, wherein said controller comprises a microcontroller for turning said power switch on and off.

16. A mobile cart for use with a battery, the mobile cart comprising:
a body;
a plurality of wheels connected to and supporting said body for rolling said body across a surface; and
a power supply system connected to said body for providing power to peripheral devices, the power supply system comprising:
an AC input device for connecting to an AC power source;
a charger connected to said AC input device;
a power switch for connection to said battery for turning power from said battery on and off;
an inverter for connection to said battery for converting direct current from said battery to alternating current for supplying AC power to a peripheral device;
a controller for controlling said power switch for turning off all power from the battery when said battery reaches a predetermined power off state of charge;
a resume switch for resuming power to said controller in response to receipt of power from said AC power source, thereby causing the controller to resume monitoring of the state of charge of said battery; and
a peripheral output for connection of said peripheral device, wherein
when said battery reaches a predetermined power off state of charge, said controller switches off said power switch and turns off all power from said battery and when said battery is recharged and reaches a predetermined restart state of charge, said controller switches on said power switch.

17. The mobile cart according to claim 16, wherein said controller further monitors battery voltage and switches off all power from said battery when said battery reaches a predetermined low voltage, and wherein when said controller resumes monitoring of the battery, power from the battery is switched back on when said battery also reaches a predetermined voltage.

18. The mobile cart according to claim 16, wherein said power supply system comprises an automatic transfer switch for automatically providing power to a load from said AC input device when connected to said AC power source.

19. The mobile cart according to claim 16, wherein said controller turns itself off to switch off power from the battery when said battery reaches said predetermined power off state of charge.

20. The mobile cart according to claim 16, wherein said resume switch comprises an analog rectifier circuit for turning on said controller.

21. The mobile cart according to claim 16, wherein said controller comprises a microcontroller for turning said power switch on and off.
